(19) United States
(12) Patent Application Publication
(10) Pub. No.: US 2011/0194723 A1
(43) Pub. Date: Aug. 11, 2011

(54) Magnetic Diaphragm and Manufacturing Method thereof

(75) Inventors: Ching-Lan Lin, Taichung (TW); Hong-Ching Her, Taichung (TW)

(73) Assignee: Merry Electronics Co., Ltd.

(21) Appl. No.: 12/703,269

(22) Filed: Feb. 10, 2010

(51) Int. Cl. H04R 1/00; H04R 31/00

(52) U.S. Cl. 381/396; 29/594

(57) ABSTRACT

An exemplary magnetic diaphragm is applied to an electro-acoustic transducer. The magnetic diaphragm has a base formed with a magnetic layer thereon by a film deposition method. The base with the magnetic layer thus has magnetism to interference with a magnetic circuit of the electro-acoustic transducer. A manufacture method of the magnetic diaphragm is also disclosed.

### BACKGROUND

1. Field of the Invention

The present invention generally relates to a magnetic diaphragm and a manufacture method thereof, and more particularly to a magnetic layer formed on a base of a magnetic diaphragm by a film deposition method and the manufacture method of the magnetic diaphragm.

2. Description of Prior Art

Recently, audio documents have many compressed formats that can drastically reduce the file size of the audio data. The replay quality of the compressed audio documents is almost equal to that of the uncompressed audio documents so that the feel of the user will not be affected. Consequentially, audio players are produced in bulk. In an audio player, a speaker used for playing an audio document is an important element. Therefore, many manufacturers of audio player pay most attention to the quality and design of the speaker.

Referring to FIG. 1, it shows a conventional speaker 10. The speaker 10 includes a case 11, a lower yoke plate 12, an upper yoke plate 13, a magnet 14, a voice coil 15 and a diaphragm 16. The lower yoke plate 12 is embedded in the case 11. The magnet 14 is disposed on the lower yoke plate 12, and the upper yoke plate 13 is disposed on the magnet 14. The voice coil 15 is shaped in ring and engaged with the diaphragm 16. The voice coil 15 is inserted in a gap between the lower yoke plate 12 and the upper yoke plate 13. Thus, the voice coil 15 is in a magnetic loop formed by the lower yoke plate 12, the upper yoke plate 13 and the magnet 14.

The above speaker 10 has a most common structure with a characteristic that attracting or repelling the magnetic circuit by providing the voice coil 15 with an electric signal for generating magnetism, so as to make the diaphragm 16 vibrate to generate a sound. Obviously, the diaphragm is most important in all the components of a speaker. It can be said, the development process of the speaker is equal to a development process of the diaphragm. When develop the diaphragm, people usually pay intention to the model, the material composition, or the molding method of the diaphragm. To get a better sound quality of a speaker, the quality, rigidity, damping, magnetic conductibility, elastic ratio, geometry, heat tolerance, wet fastness, and manufacture difficulty level of the diaphragm are needed to be considered. Therefore, the material of the diaphragm is almost selected during paper stuff, plastic, metal, composite material, cloth, silk, gunny, alga and bacterium. Different materials have different characters so that the designers can select a collocation according to a sound quality requirement of the speaker.

In addition, electronic devices are trending to be small and thin. How the sound quality can be kept or much better and the reduced or shortened component becomes a question for the speaker designers. Further, the diaphragm can be vibrated only through an engagement with the voice coil, thus, a process of the diaphragm and the voice coil that is with high cost must be added. Therefore, a multi-functional diaphragm that can reduce components is important and required.

### SUMMARY

One objective of the present invention is to provide a magnetic layer formed on a base of a magnetic diaphragm by a film deposition method and a manufacture method of the magnetic diaphragm.

In a first aspect of an embodiment of the present invention, a magnetic diaphragm is provided for being applied to an electro-acoustic transducer. The magnetic diaphragm includes a base, and the magnetic material is deposited on the base by a film deposition method to form a magnetic layer. The base with the magnetic layer thus has magnetism to interference with a magnetic circuit of the electro-acoustic transducer.

In a second aspect, a manufacture method of the magnetic diaphragm includes following steps: a preparation process for providing a base of a diaphragm; a film deposition process of forming a magnetic layer on the base by depositing a magnetic material; a heating process of heating the base with the magnetic layer for molding; and a cutting process of cutting the molded base into predetermined size.

In the present invention, a magnetic film is formed on the nonmagnetic base by deposition of the magnetic material. Thus, when the magnetic diaphragm is applied to a common speaker or the other electro-acoustic transducers, a magnetic flux of the magnetic circuit can be increased, and the magnetism and the loudness control of the speaker are both promoted. In addition, when the magnetic diaphragm itself having magnetism is clipped between two magnetic loops of the electro-acoustic transducer so that the magnetic diaphragm can vibrate between the two magnetic loops for generating sound. Thus, the magnet can be omitted in the present invention so that the structure is advantaged for a thin design of the electro-acoustic transducer.

### BRIEF DESCRIPTION OF THE DRAWINGS

The accompanying drawings are included to provide a further understanding of the invention, and are incorporated in and constitute part of this specification. The drawings illustrate embodiments of the invention and, together with the description, serve to explain the principles of the invention.

FIG. 1 is a schematic cross-sectional view of a speaker according to the prior art.

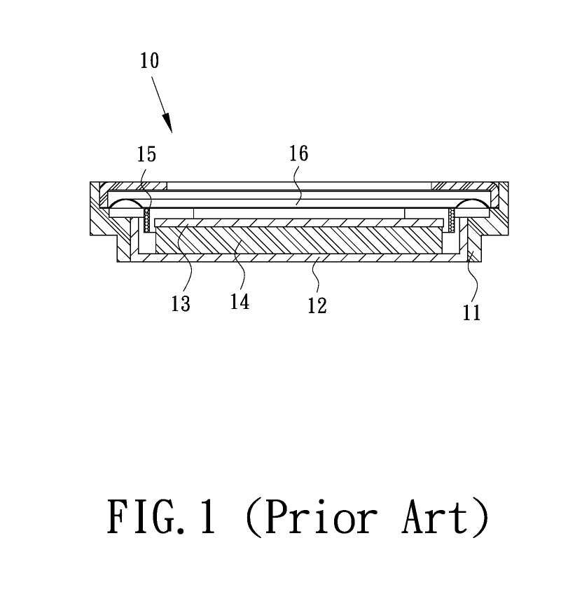

FIG. 2 is a schematic view of a manufacture process of a magnetic diaphragm in accordance with a preferred embodiment of the present invention.

FIG. 3 is a schematic view of the magnetic diaphragm shown in FIG. 2 applied to a speaker.

### DETAILED DESCRIPTION

With reference of the drawings, a magnetic diaphragm and the manufacture method thereof in accordance with a preferred embodiment of the present invention are described as follows.

A magnetic diaphragm is provided for being applied exemplarily to an electro-acoustic transducer, such as a speaker. When applied to the speaker, the speaker has an electric signal generating a magnetic field to make the diaphragm vibrating and generating a sound signal. The magnetic diaphragm includes a base having magnetic material deposited on the base by a film deposition method to form a magnetic layer. The base with the magnetic layer thus has magnetism to interference with a magnetic circuit of the speaker.

Further, the magnetic diaphragm applied to an electro-acoustic transducer can be manufactured with the following process: a preparation process for providing a base of a diaphragm; a film deposition process of forming a magnetic layer by depositing a magnetic material; a heating process of heating the base with the magnetic layer for molding; and a cutting process of cutting the molded base into predetermined size.

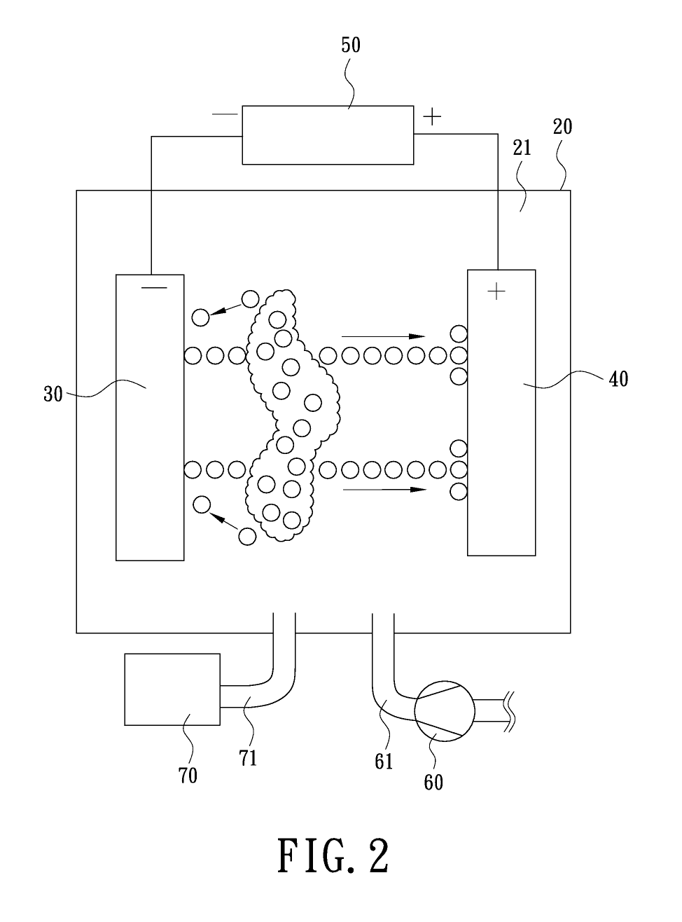

Referring to FIG. 2, it shows a schematic view of a manufacture process of a magnetic diaphragm with exemplarily a physical vapor deposition (PVD) method. First, a magnetic material is used to generate at least one microparticulate, and the microparticulate is deposited on a base of a diaphragm. The PVD method usually includes vacuum evaporation method and sputtering method. In the embodiment, the magnetic diaphragm is manufactured by the sputtering method.

FIG. 2 shows a work carrier 20 forming a sealed space 21 therein. The sealed space 21 includes a magnetic material 30 and a base 40. The work carrier 20 is configured with a power supply 50, a vacuum pump 60 and an ion operating apparatus 70. The negative electrode of the power supply 50 is electronically connected to the magnetic material 30, and the positive electrode is connected to the base 40. The vacuum pump 60 has a vacuum pipe 61 inserting into the sealed space 21 to exhaust the air from the sealed space 21, and the sealed space 21 is in a vacuum state. The ion operating apparatus 70 has an output pipe 71 inserting into the sealed space 21 for generating ions to attack the magnet material 30 for generating microparticulate.

In the embodiment, the magnetic material 30 can be soft magnetic material or hard magnetic material. The soft magnetic material is exemplarily selected one pure element or a collocation from the group consisted of iron, low-carbon steel, iron silicon alloy, iron aluminium alloy, iron silicon aluminium alloy, nickel iron alloy, iron cobalt alloy, soft magnetic ferrite, amorphous soft magnetic alloy and microcrystal soft magnetic alloy. The hard magnetic material is exemplarily selected one pure element or a collocation from the group consisted of ferrite permanent magnet material, aluminium-nickel-cobalt permanent magnet material, thulium permanent magnet material, iron-chrome-cobalt permanent magnet material, iron-nickel-copper permanent magnet material, platinum cobalt permanent magnet material and iron platinum permanent magnet material.

In addition, the material of the base 40 is exemplarily selected one pure element or a collocation from the group consisted of metal, plastic, cloth, paper and oxides.

The ions produced by the ion operating apparatus 70 can be inert gas such as argon ion. When the ions produced by the ion operating apparatus 70 attack the magnetic material 30, microparticulate on gas are produced to deposit on the base 40. The sputter method is common due to the process thereof has advantages of being unpolluted, good adhesion, and almost all materials can be deposited. Further, to make the microparticulate on the base 40 have magnetism, a crystallization process of crystallizing the microparticulate is needed.

The microparticulate crystallization process can be implemented in the several ways. In follows, the process is illustrated by examples that can be replaced with the other similar crystallization processes or essentially equivalent crystallization processes.

In a first exemplary method, after the magnetic material 30 is deposited on the base 40 by a sputtering method, a film is formed on the base 40 by the magnetic material 30. The base 40 with the film is put into a high temperature vacuum furnace for the heating process. In the heating process, air in the high temperature vacuum furnace is exhausted for a vacuum state of the high temperature vacuum furnace. The temperature of the high temperature vacuum furnace is increased to 600° C. or above in a heating rate of 4˜5° C. per minute, and held in the temperature for about 20 minutes. Then, the temperature of the high temperature vacuum furnace is decreased to normal temperature so that the magnetic material 30 on the base 40 is crystallized.

In a second exemplary method, after the ions attack the magnetic material 30 to produce microparticulate, the work carrier for sputtering is heated to 600° C. or above. The microparticulate through a high temperature area are crystallized. A film is formed by the crystallized magnetic material depositing on the surface of the base 40.

With the above manufacture methods, a magnetic film can be formed on the nonmagnetic base 40 by deposition of the magnetic material 30. Thus, when the magnetic diaphragm is applied to a speaker or the other electro-acoustic transducers, a magnetic flux of the magnetic loop is increased. Therefore, the speaker has a good magnetism and the loudness control thereof is promoted.

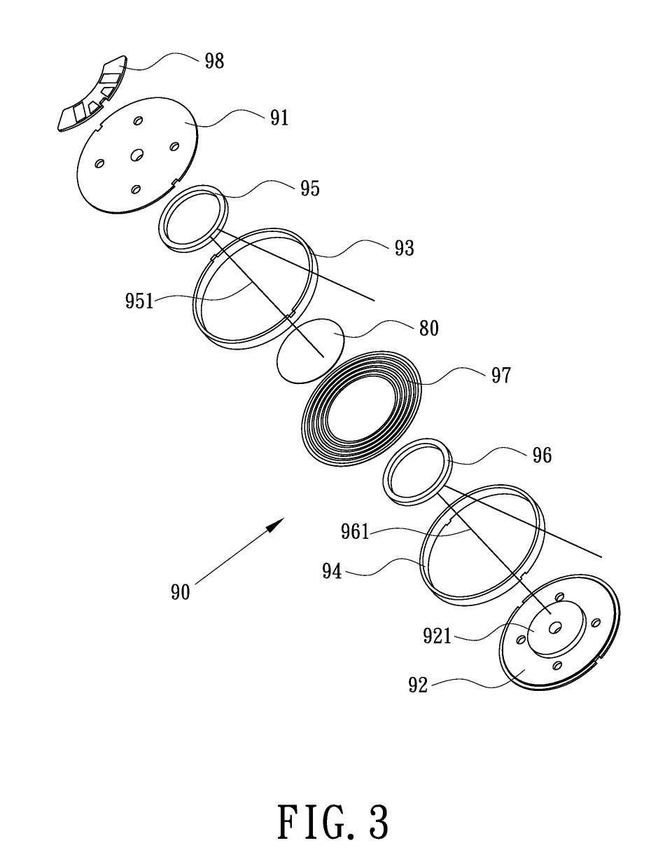

Further, referring to FIG. 3, it shows a speaker 90 having a magnetic diaphragm 80. The speaker 90 includes a first yoke plate 91, a second yoke plate 92, a first support 93, a second support 94, a first voice coil 95, a second voice coil 96, a silicon steel sheet 97 and a circuit board 98. The first yoke plate 91 and the second yoke plate 92 are both disk-shaped. The first support 93 and the second support 94 are both ring-shaped and configured on a peripheral edge of the first yoke plate 91 and the second yoke plate 92 respectively. The first voice coil 95 and the second coil 96 are respectively coiled around a protrusion (not labeled) on the first yoke plate 91 and a protrusion 921 on the second yoke plate 92. The magnetic diaphragm 80 attached on the silicon steel sheet 97 is clipped between the first support 93 and the second support 94. The circuit board 98 is configured in one end (without the protrusion) of the first yoke plate 91 and electronically connected to the leading wires 951, 961 of the first voice coil 95 and the second voice coil 96.

In use, an electric signal is transmitted to the first voice coil 95 and the second voice coil 96 in accordance with requirement for generating magnetism. The speaker 90 has a first magnetic loop and a second magnetic loop in the meantime. When the two magnetic loops generate two corresponding magnetism and magnetize alternately, the magnetic diaphragm 80 clipped between the two magnetic loops actively attracts the two magnetic circuits, and thus the magnetic diaphragm 80 is vibrated up and down for generating a sound.

Obviously, the magnetic diaphragm 80 has magnetism itself, thus, the magnet of the conventional speaker can be omitted. The magnetic diaphragm 80 can be vibrated to generate a sound through attracting or repelling the magnetic circuits thereabove and therebelow. As a result, the original function of the speaker is not affected.

At last, it should be pointed out that, except for the above exemplary physical vapor deposition (PVD) for producing the magnetic diaphragm, chemical vapor deposition (CVD) method can also be adopted for producing the magnetic diaphragm. Now, common CVD technologies include atmospheric pressure CVD (APCVD) system, low pressure CVD (LPCVD) system, plasma enhanced CVD (PECVD) system, and high density plasma CVD (HDP CVD) system.

As stated above, in the present invention, a magnetic film is formed on the nonmagnetic base by deposition of the magnetic material. Thus, when the magnetic diaphragm is applied to a speaker or the other electro-acoustic transducers, a magnetic flux of the magnetic circuit can be increased, and the magnetism and the loudness control of the speaker are both promoted. In addition, the magnetic diaphragm itself has active magnetic attracting and repelling function, thus, the magnet of the conventional speaker can be replaced. When the magnetic diaphragm is applied to an electro-acoustic transducer with two magnetic circuits, the magnetic diaphragm can be vibrated by reciprocating attracting and repelling the two magnetic circuits. The structure is an advantaged design, and the good original function of the speaker is reserved.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A magnetic diaphragm for being applied to an electro-acoustic transducer, comprising:
a base formed with a magnetic layer thereon by a film deposition method, the magnetic layer being formed by depositing a magnetic material on the base, the base with the magnetic layer thus having magnetism to interference with a magnetic loop of the electro-acoustic transducer.

2. The magnetic diaphragm as claimed in claim 1, wherein the magnetic diaphragm is configured in a speaker.

3. The magnetic diaphragm as claimed in claim 1, wherein the magnetic material is soft magnetic material.

4. The magnetic diaphragm as claimed in claim 3, wherein the soft magnetic material is selected from the group consisting of iron, low-carbon steel, iron silicon alloy, iron aluminium alloy, iron silicon aluminium alloy, nickel iron alloy, iron cobalt alloy, soft magnetic ferrite, amorphous soft magnetic alloy, microcrystal soft magnetic alloy, and a collocation of above materials.

5. The magnetic diaphragm as claimed in claim 1, wherein the magnetic material is hard magnetic material.

6. The magnetic diaphragm as claimed in claim 3, wherein the hard magnetic material is selected from the group consisting of ferrite permanent magnet material, aluminium-nickel-cobalt permanent magnet material, thulium permanent magnet material, iron-chrome-cobalt permanent magnet material, iron-nickel-copper permanent magnet material, platinum cobalt permanent magnet material, iron platinum permanent magnet material, and a collocation of above materials.

7. The magnetic diaphragm as claimed in claim 1, wherein the material of the base is selected from the group consisting of metal, plastic, cloth, paper, oxides and a collocation of above materials.

8. The magnetic diaphragm as claimed in claim 1, wherein the magnetic material is deposited on the base by a physical vapor deposition method.

9. The magnetic diaphragm as claimed in claim 1, wherein the magnetic material is deposited on the base by a chemical vapor deposition method.

10. A manufacture method of a magnetic diaphragm, comprising following steps:
a preparation process of providing a base of a diaphragm;
a film deposition process of forming a magnetic layer on the base by depositing a magnetic material;
a heating process of heating the base of the magnetic layer for molding; and
a cutting process of cutting the molded base into predetermined size.

11. The manufacture method of the magnetic diaphragm as claimed in claim 10, wherein at leas one microparticulate is excited from the magnetic material by a physical vapor deposition method and the microparticulate is deposited on the base of the diaphragm.

12. The manufacture method of the magnetic diaphragm as claimed in claim 11, wherein the magnetic material is deposited on the base by vacuum evaporation method.

13. The manufacture method of the magnetic diaphragm as claimed in claim 11, wherein the magnetic material is deposited on the base by sputtering method.

14. The manufacture method of the magnetic diaphragm as claimed in claim 11, wherein after the microparticulate is deposited on the base, the base with the microparticulate deposited thereon is put into a high temperature vacuum furnace with a anneal treatment for crystallizing the microparticulate.

15. The manufacture method of a magnetic diaphragm as claimed in claim 11, wherein the microparticulate is deposited on the base after through a high temperature area.

16. The manufacture method of a magnetic diaphragm as claimed in claim 15, wherein the temperature in the high temperature area is above 600° C.

17. The manufacture method of a magnetic diaphragm as claimed in claim 10, wherein the magnetic material is deposited on the base by a chemical vapor deposition method.

18. The manufacture method of a magnetic diaphragm as claimed in claim 17, wherein the chemical vapor deposition method is selected from the group consisting of atmospheric pressure CVD system, low pressure CVD system, plasma enhanced CVD system, and high density plasma CVD system.
